(19) United States
(12) Patent Application Publication
(10) Pub. No.: US 2026/0336457 A1
(43) Pub. Date: Oct. 29, 2026

(54) PUBLIC CHARGING WAIT-TIME ESTIMATION AND PREDICTION

(71) Applicant: Ford Global Technologies, LLC, Dearborn, MI (US)

(72) Inventors: Kai Wu, Pittsburgh, PA (US); Shaozhong Zhao, Canton, MI (US); Najibesadat Sadatijafarkalaei, McKinney, TX (US); Chen Zhang, South Lyon, MI (US); Yan Fu, Bloomfield, MI (US); James Gawron, Rochester Hills, MI (US); Afsoun Rahnama Falavarjani, Rochester Hills, MI (US)

(21) Appl. No.: 19/191,374

(22) Filed: Apr. 28, 2025

(51) Int. Cl. B60L 53/66; B60L 53/62; B60L 53/68

(52) U.S. Cl. CPC B60L 53/66; B60L 53/68; B60L 53/62; B60L 2240/72

(57) ABSTRACT

Predicting a wait time for an electric vehicle (EV) at a charging station is performed. A server receives a charger request from an EV including at least a destination and a state of charge (SOC) value. An arrival rate of EVs to the charging station is determined based on at least one of: vehicle density in a geofenced region around the charging station or SOC values of nearby EVs; A service rate of the charging station is determined based on historical charging event data. A trained prediction model is applied to the request based on the arrival rate and the service rate to estimate a predicted wait time for the EV at the charging station. The predicted wait time is transmitted to a user interface associated with the EV.

### TECHNICAL FIELD

Aspects of the disclosure generally relate to public charging wait-time estimation and prediction, based on a hybrid approach using physics-based models and data-driven techniques.

### BACKGROUND

Electric Vehicle Supply Equipment (EVSE) refers to the infrastructure and devices used to deliver electrical energy from the power grid to an electric vehicle (EV) for the purpose of recharging its battery. EVSE includes components such as connectors, cables, communication protocols, and mechanisms that provide a flow of electricity and ensure secure and efficient charging. Wait times for use of EVSEs can vary significantly depending on factors such as charger type, charging speed, and station availability.

### SUMMARY

In one or more illustrative examples, a method for predicting a wait time for an electric vehicle (EV) at a charging station includes receiving, at a server, a charger request from an EV including at least a destination and a state of charge (SOC) value; determining an arrival rate of EVs to the charging station based on at least one of: vehicle density in a geofenced region around the charging station or SOC values of nearby EVs; determining a service rate of the charging station based on historical charging event data; applying a trained prediction model to the request based on the arrival rate and the service rate to estimate a predicted wait time for the EV at the charging station; and transmitting the predicted wait time to a user interface associated with the EV.

In one or more illustrative examples, the trained prediction model is based on historical wait times determined using Level 1 short trip identification using trip distance and odometer change thresholds; and Level 2 short trip identification using segmentation of trip gear patterns into sub-trips and evaluation of a final sub-trip based on duration and odometer change.

In one or more illustrative examples, the method further includes generating training data for the prediction model by receiving, at the server, charging event data including plug-in timestamps associated with charging sessions for a plurality of EVs; retrieving, from a vehicle history database, a plurality of trips associated with the plurality of EVs; for each EV: identifying, from the plurality of trips, a final trip ending before the plug-in timestamp; determining whether the final trip is a Level 1 short trip after a preceding trip based on one or more of: a trip distance of the final trip being less than a threshold value and an odometer change of the final trip being less than or equal to a predefined threshold; responsive to the final trip not satisfying Level 1 short trip criteria, further determining analyzing a gear pattern of the final trip to determine whether the gear pattern includes a last sub-trip meeting criteria for being a Level 2 short trip, the last sub-trip being usable as the final trip and a prior sub-trip or trip being usable as the preceding trip; and responsive to the final trip being a Level 1 short trip or a Level 2 short trip, determining a historical wait time as a difference between an end time of the final trip and an end time of the preceding trip; wherein the historical wait times are aggregated and used to train the prediction model.

In one or more illustrative examples, the method further includes excluding the final trip from being the Level 1 short trip as an adjustment case responsive to the trip distance being below an adjustment distance threshold and the difference between the end time of the final trip and the end time of the preceding trip being less than an adjustment time threshold.

In one or more illustrative examples, determining the Level 2 short trip includes segmenting the final trip into a plurality of sub-trips based on the gear pattern; identifying a last sub-trip prior to the plug-in timestamp; and determining whether the last sub-trip is a Level 2 short trip based on a duration of the sub-trip being less than a Level 2 duration threshold and an odometer change of the sub-trip being less than or equal to a Level 2 predefined threshold.

In one or more illustrative examples, the segmenting is performed when the gear pattern matches a pattern of alternating Park and Drive gear positions.

In one or more illustrative examples, the method further includes verifying whether a charger was available at a time of the plug-in timestamp by analyzing a charger occupancy status.

In one or more illustrative examples, responsive to determining that at least one charger was available at the plug-in timestamp, the wait time is recorded as zero.

In one or more illustrative examples, the trained prediction model comprises a queuing model, wherein the queuing model is one of an M/M/m model, an M/D/m model, or an M/G/m model.

In one or more illustrative examples, determining the arrival rate includes assigning a charging probability to each EV within the geofenced region based on a SOC threshold; and weighting the arrival rate using a popularity score of the charging station.

In one or more illustrative examples, a server for predicting a wait time for an electric vehicle (EV) at a charging station includes a memory storing instructions of a charger service; and one or more computing devices configured to execute the instructions to perform operations including to receive a charger request from an EV including at least a destination and a state of charge (SOC) value, determine an arrival rate of EVs to the charging station based on at least one of: vehicle density in a geofenced region around the charging station or SOC values of nearby EVs, determine a service rate of the charging station based on historical charging event data, apply a trained prediction model to the request based on the arrival rate and the service rate to estimate a predicted wait time for the EV at the charging station, and transmit the predicted wait time to a user interface associated with the EV.

In one or more illustrative examples, the trained prediction model is based on historical wait times determined using Level 1 short trip identification using trip distance and odometer change thresholds; and Level 2 short trip identification using segmentation of trip gear patterns into sub-trips and evaluation of a final sub-trip based on duration and odometer change.

In one or more illustrative examples, the one or more computing devices are further configured to execute the instructions to perform operations to generate training data for the prediction model including to: receive at the server, charging event data including plug-in timestamps associated with charging sessions for a plurality of EVs; receive, from a vehicle history database, a plurality of trips associated with the plurality of EVs; for each EV: identify, from the plurality of trips, a final trip ending before the plug-in timestamp; determine whether the final trip is a Level 1 short trip after a preceding trip based on one or more of: a trip distance of the final trip being less than a threshold value and an odometer change of the final trip being less than or equal to a predefined threshold; responsive to the final trip not satisfying Level 1 short trip criteria, further determine analyzing a gear pattern of the final trip to determine whether the gear pattern includes a last sub-trip meeting criteria for being a Level 2 short trip, the last sub-trip being usable as the final trip and a prior sub-trip or trip being usable as the preceding trip; and responsive to the final trip being a Level 1 short trip or a Level 2 short trip, determine a historical wait time as a difference between an end time of the final trip and an end time of the preceding trip; wherein the historical wait times are aggregated and used to train the prediction model.

In one or more illustrative examples, the one or more computing devices are further configured to execute the instructions to perform operations including to exclude the final trip from being the Level 1 short trip as an adjustment case responsive to the trip distance being below an adjustment distance threshold and the difference between the end time of the final trip and the end time of the preceding trip being less than an adjustment time threshold.

In one or more illustrative examples, to determine the Level 2 short trip includes to segment the final trip into a plurality of sub-trips based on the gear pattern; identify a last sub-trip prior to the plug-in timestamp; and determine whether the last sub-trip is a Level 2 short trip based on a duration of the sub-trip being less than a Level 2 duration threshold and an odometer change of the sub-trip being less than or equal to a Level 2 predefined threshold.

In one or more illustrative examples, the segmentation is performed when the gear pattern matches a pattern of alternating Park and Drive gear positions.

In one or more illustrative examples, the one or more computing devices are further configured to execute the instructions to perform operations including to verify whether a charger was available at a time of the plug-in timestamp by analyzing a charger occupancy status.

In one or more illustrative examples, responsive to determining that at least one charger was available at the plug-in timestamp, the wait time is recorded as zero.

In one or more illustrative examples, the trained prediction model comprises a queuing model, wherein the queuing model is one of an M/M/m model, an M/D/m model, or an M/G/m model.

In one or more illustrative examples, determining the arrival rate includes to assign a charging probability to each EV within the geofenced region based on a SOC threshold; and weight the arrival rate using a popularity score of the charging station.

In one or more illustrative examples, a non-transitory computer-readable medium comprising instructions of a charger service for predicting a wait time for an electric vehicle (EV) at a charging station that, when executed by one or more computing devices of a charger server, cause the charger server to perform operations including to receive at the server, charging event data including plug-in timestamps associated with charging sessions for a plurality of EVs; receive, from a vehicle history database, a plurality of trips associated with the plurality of EVs; for each EV, determine historical wait times including to: identify, from the plurality of trips, a final trip ending before the plug-in timestamp; determine whether the final trip is a Level 1 short trip after a preceding trip based on one or more of: a trip distance of the final trip being less than a threshold value and an odometer change of the final trip being less than or equal to a predefined threshold; responsive to the final trip not satisfying Level 1 short trip criteria, further determine analyzing a gear pattern of the final trip to determine whether the gear pattern includes a last sub-trip meeting criteria for being a Level 2 short trip, the last sub-trip being usable as the final trip and a prior sub-trip or trip being usable as the preceding trip; and responsive to the final trip being a Level 1 short trip or a Level 2 short trip, determine a historical wait time as a difference between an end time of the final trip and an end time of the preceding trip; receive a charger request from an EV including at least a destination and a state of charge (SOC) value; determine an arrival rate of EVs to the charging station based on at least one of: vehicle density in a geofenced region around the charging station or SOC values of nearby EVs; determine a service rate of the charging station based on historical charging event data; apply to the request, a model trained using the historical wait times, based on the arrival rate and the service rate to estimate a predicted wait time for the EV at the charging station; and transmit the predicted wait time to a user interface associated with the EV.

### BRIEF DESCRIPTION OF THE DRAWINGS

FIG. 1 illustrates an example system for performing public charging wait-time estimation and prediction for charging vehicles;

FIG. 2 illustrates a single step charging plot which involves no waiting;

FIG. 3 illustrates a two-step charging plot which does involve waiting;

FIG. 4 illustrates an example delivery trip for a vehicle;

FIG. 5 illustrates a graph of the distribution of trip distance for Level 1 short trips;

FIG. 6 illustrates an example data collection for a first gear pattern for a Level 2 analysis;

FIG. 7 illustrates an example data collection for a second pattern for the Level 2 analysis;

FIG. 8 illustrates an example of breaking down a trip into two, where the second trip is not a short trip;

FIG. 9 illustrates an example of breaking down a trip into two, where the second trip is a short trip;

FIG. 10 shows a trip with multiple trip patterns;

FIG. 11 illustrates an example process for public charging wait-time estimation and prediction;

FIG. 12 illustrates an example process for responding to charger requests; and

FIG. 13 illustrates an example computing device for implementing aspects of public charging wait-time estimation and prediction.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As EV adoption continues to rise, congestion at popular EV charging stations is becoming an increasing frustration for drivers and presents a new challenge for charge point operators (CPOs). To alleviate charging anxiety for EV drivers, it may be desirable to provide an estimation of charger wait times. Offering near real-time predictions of wait times by leveraging streaming data may also provide drivers with more flexibility, allowing them to adjust their trips or plan activities while waiting.

Aspects of the disclosure relate to an approach to providing a public charging wait-time digital service. The approach may offer wait-time estimation using vehicle data, wait-time adjustment using regional EV density data, and/or real-time wait-time prediction upon arrival.

The wait-time estimation may include estimating EV public charging wait times by passively analyzing vehicle data, rather than relying on driver surveys. The wait-time estimation may be informed by an identification of “short trips,” which refers to the short vehicle movements approaching an EVSE after waiting for an open charger. By integrating vehicle geospatial information (e.g., global navigation satellite system (GNSS) locations) and trip data (including trip start/end times, gear, and ignition status) with charging event data (such as charging start time), the system identifies these “short trip” that represents a driver's wait time between arrival and charging. Additionally, the wait-time estimation cross-references EVSE streaming status at the same time to eliminate outliers and enhance accuracy.

Moreover, the approach enhances customer experience by dynamically adjusting wait-time estimates based on regional EV density data. When customers confirm their charging destination, the approach integrates statistical data with backend queuing models. For a specific charging station, the total sojourn time is conceptualized as the sum of the waiting time in the queue and the charging service time.

This may include employing either first principal modeling techniques or data-driven methods to estimate the charging service time, depending on the available data-such as the type of vehicle currently being serviced, the targeted state of charge (SOC), and the EVSE charging performance status. The service rate (u), which reflects the charging time can be modeled using either a Markov chain or a deterministic system.

The approach may also open a geospatial region and gather extensive xEV data. By evaluating the density of EVs with low SOC that are driving nearby, as well as specific service requests obtained through third-party routing systems (for example, the number of drivers who have confirmed the current charging station as their destination), the approach may transform this information into an anticipated arrival rate (2).

The total sojourn time may be modeled, and the anticipated wait-time may be updated frequently to show on customers' phone or vehicle Human Machine Interface (HMI). Upon a customer's arrival at the charging station, the approach employs a combination of physics-based modeling techniques and data-driven methods to deliver real-time wait-time updates.

If comprehensive information about the targeted SOC for both currently served and waiting vehicles is available, a deterministic wait-time estimation may be performed. This model assumes that customers adhere to charging etiquette by unplugging their vehicles once the targeted SOC is reached. To enhance accuracy, historical trends may be analyzed to incorporate a time factor to provide indications for scenarios where there is a long plug time with a short charging duration, which can indicate a longer wait-time at the charging station.

In situations where targeted SOC information is not available, but the number of vehicles in line is visible to customers, data-driven approaches may be relied upon. An initial wait-time estimation may be enhanced by breaking it down according to the number of vehicles in line. This approach dynamically displays a wait-time estimate for each position in the queue, allowing customers to better plan their activities while waiting. Furthermore, the vehicle HMI or phone app (such as FordPass) may be leveraged to collect customers' inputs on wait-time in order to update the current congestion situation more accurately.

The approach may also provide personalized recommendations for nearby amenities and activities based on the predicted wait time, transforming the charging wait into a more productive and enjoyable experience. By leveraging real-time data and historical insights, the disclosed approach optimizes the charging process and enhances customer satisfaction.

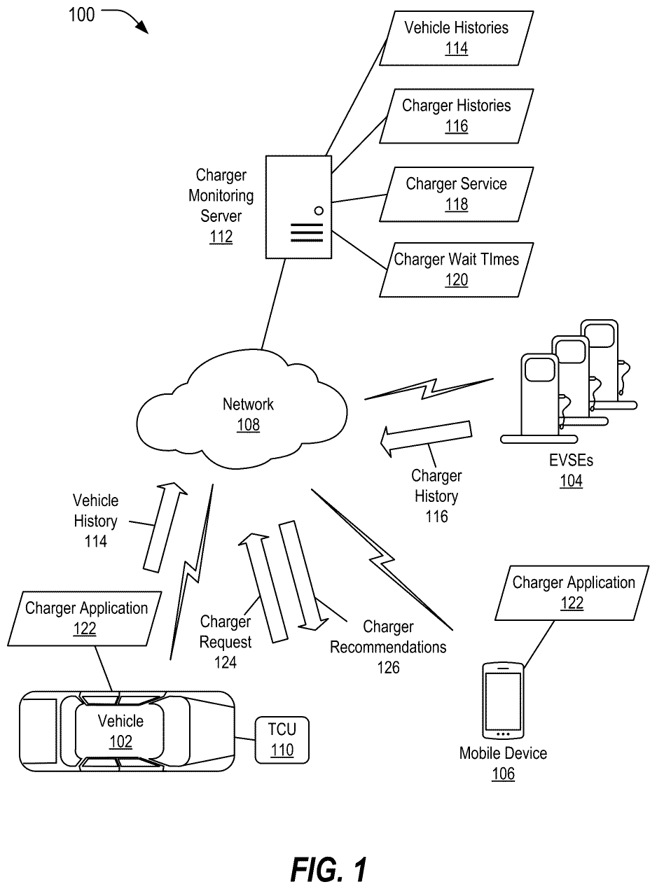

FIG. 1 illustrates an example system 100 for performing public charging wait-time estimation and prediction for charging vehicles 102. The vehicles 102, EVSEs 104, mobile devices 106, and charger monitoring server 112 may be configured to communicate over a communications network 108. The charger monitoring server 112 may be configured to receive vehicle histories 114 from the vehicles 102 and charger histories 116 from the EVSEs 104. Using the vehicle histories 114 and charger histories 116, a charger service 118 hosted by the charger monitoring server 112 may be configured to generate charger wait times 120 that may be used to handle charger requests 124 to provide charger recommendations 126 to users of the vehicles 102 and/or the mobile devices 106. It should be noted that the system 100 is only an example, and examples with more, fewer, or differently located components may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be a battery electric vehicle (BEV) powered by a traction battery and one or more electric motors. As a further possibility, the vehicle 102 may be a hybrid electric vehicle powered by both an internal combustion engine, a traction battery, and one or more electric motors. Hybrid vehicles 102 may come in various forms, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs), globally unique identifiers (GUIDs), customer or fleet accounts, etc.

The EVSEs 104 may be configured to manage the transfer of energy between a power source and the vehicle 102. An external power source may provide direct current (DC) or alternating current (AC) electric power to the EVSEs 104. The EVSEs 104 may, in turn, have a charge connector for plugging into a respective charge port of the vehicle 102. The charge port may be any type of port configured to transfer power from the EVSEs 104 to the vehicle 102. Alternatively, the EVSEs 104 may be configured to transfer power using other approaches, such as a wireless inductive coupling. However connected, the EVSEs 104 may include circuitry and controls to manage the transfer of energy between the power source and the vehicle 102.

The mobile device 106 may be any of various types of portable computing device, such as cellular phones, tablet computers, smart watches, laptop computers, portable music players, or other devices having processing and communications capabilities. The mobile device 106 may include one or more processors configured to execute computer instructions, and a storage medium on which the computer-executable instructions and/or data may be maintained.

The mobile device 106 may further include various wireless transceivers, such as a BLUETOOTH or BLUETOOTH Low Energy (BLE) transceiver, as well as a transceiver for communication over the communications network 108. The communications network 108 may include one or more interconnected communication networks such as the Internet, a cable television distribution network, a satellite link network, a local area network, and a telephone network, as some non-limiting examples. The vehicle 102 may also include a telematics control unit (TCU) 110. The TCU 110 may include network hardware configured to facilitate communication between the vehicle 102 and other devices of the system 100. For example, the TCU 110 may include or otherwise access a cellular modem configured to facilitate communication with the communications network 108.

The charger monitoring server 112 may be an example of a networked computing device that is accessible to the vehicles 102, EVSEs 104, and/or mobile devices 106 over the communications network 108. The charger monitoring server 112 may be configured to receive charger histories 116 from the EVSEs 104 over the charger monitoring server 112 (e.g., as part of a billing process for EVSEs 104 usage or as a separate process). In another example, vehicle 102 may monitor its usage of the EVSEs 104, and may send its charger history 116 over the over the communications network 108 to the charger monitoring server 112.

The vehicle histories 114 may include usage information about the vehicle 102. This usage information may include, for example the locations of the vehicle 102 over time, times when the vehicle 102 changed from park to drive, times when the vehicle 102 changed from drive to park, etc.

The charger histories 116 may include information with respect to vehicle 102 usage of the EVSEs 104. This information may include, as some non-limiting examples: a time at which an EVSE 104 begins to charge a vehicle 102, a time at which an EVSE 104 stops to charging the vehicle 102, average charge rate for the charge of the vehicle 102, charge over time rate for the charge of the vehicle 102, an identifier of the EVSE 104, an identifier of the vehicle 102, whether an issue occurred during the charge of the vehicle 102, expense per kWh for the charge, etc. The charger histories 116 may also include information regarding the vehicles 102 that utilize the EVSEs 104. For instance, the charger histories 116 may also include identifiers of the vehicles 102 (e.g., VIN, GUID, user account, etc.), make, model, and/or type of the vehicle 102, age of the vehicle 102, battery health of the vehicle 102, mileage of the vehicle 102, initial charge level of the vehicle 102, ending charge level of the vehicle 102.

The charger service 118 may be an example of an application executed by the charger monitoring server 112. As explained in further detail herein, the charger service 118 may be configured to receive the vehicle histories 114 and the charger histories 116, generate charger wait times 120, and use those generated charger wait times 120 to inform vehicles 102 of the timing. In an example, the wait times 120 may be used to reply to charger requests 124 with charger recommendations 126 tailored to the vehicle 102 to be charged (e.g., with the best timing).

Further aspects of the charger wait times 120 are discussed in detail herein. These aspects may include (i) detecting charging scenarios, (ii) identifying the type of wait scenario, (iii) calculating Level 1 and Level 2 short trips, and (iv) performing the wait time 120 calculation. Each of these is discussed in turn.

There may be two main different scenarios that may occur when a customer goes to charge their vehicle 102 at an EVSE 104. As one possibility, there is at least one available EVSE 104 at the charging station. If so, the customer may charge immediately. As another possibility, all of the EVSEs 104 may be in use, and the customer may be required to wait for one to become available before charging.

These two scenarios may be categorized as either single step charging (no wait), and two step charging (wait). In the single step charging, the customer directly drives up to the EVSE 104 and begins charging. In the two-step charging, the customer drives to the charging stations, stops or parks, and waits for the EVSE 104 to be become available. Then, the customer again moves the vehicle 102, this time to the EVSE 104 to begin charging.

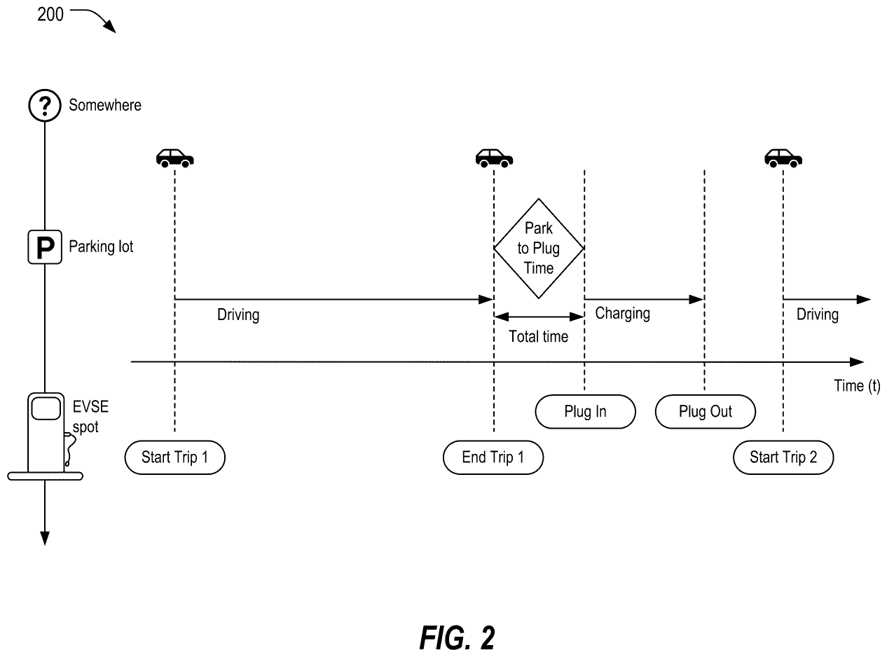

FIG. 2 illustrates a single step charging plot 200 which involves no waiting. The single step charging plot 200 depicts the space-time coordinates of the customer's trip to charge their vehicle 102, with the space vertically down on the left, and time horizontally across on the right. The plot begins from an initial location (labeled as “somewhere” in space and “start trip 1” in time), then arrives at the charging station (labeled as “EVSE spot” in space and “end trip 1” in time), and starts charging the vehicle. After charging, the vehicle 102 resumes driving and leaves the charging station (labeled as “start trip 2” in time).

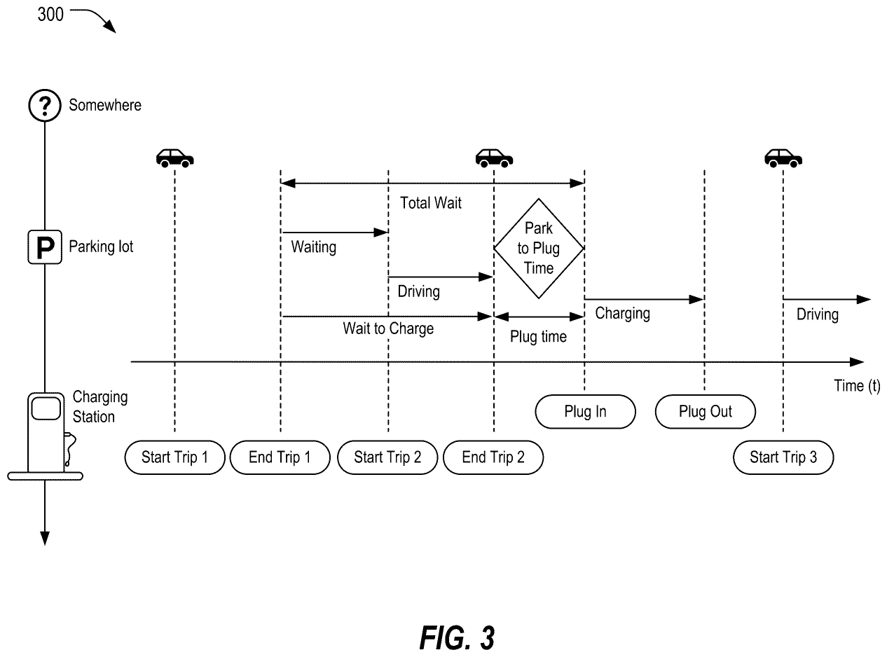

FIG. 3 illustrates a two-step charging plot 300, which does involve waiting. The two-step charging plot 300 again depicts the space-time coordinates of the customer's trip to charge their vehicle 102, with the space vertically down on the left, and time horizontally across on the right. Similar to the single step charging scenario, the customer begins from an initial location but ends their first trip at a parking area near the charging station instead of at the EVSE 104, as no EVSE 104 is available upon arrival (labeled as “parking lot” in space and “end trip 1” in time). The customer waits in the parking area. As soon as the EVSE 104 becomes available, the customer moves the vehicle 102 to the EVSE 104 (labeled as “start trip 2” in time), stops at the EVSE 104 (labeled as “end trip 2” in time), and proceeds to charge the vehicle 102. After completing the charging process, the customer leaves the charging station (labeled as “start trip 3” in time). In this scenario, the time between the end of trip 1 and the end of trip 2 is considered wait time. This is an extra time the customer must spend at the EVSE 104 compared to the first scenario.

To model the wait time for instances of the single step scenario, the sole trip is used for modeling the wait. However, for instances of the two-step charging scenario, the wait time 120 for these cases is calculated based on the timestamps of the trips prior to the respective charging.

In the two-step charging scenario (wait case), the last trip before charging is a journey from a parking area near the charging station to the EVSE 104. This means that this trip is most likely very short. Therefore, a goal is to identify a short trip preceding the charging and then calculate the wait time 120 accordingly.

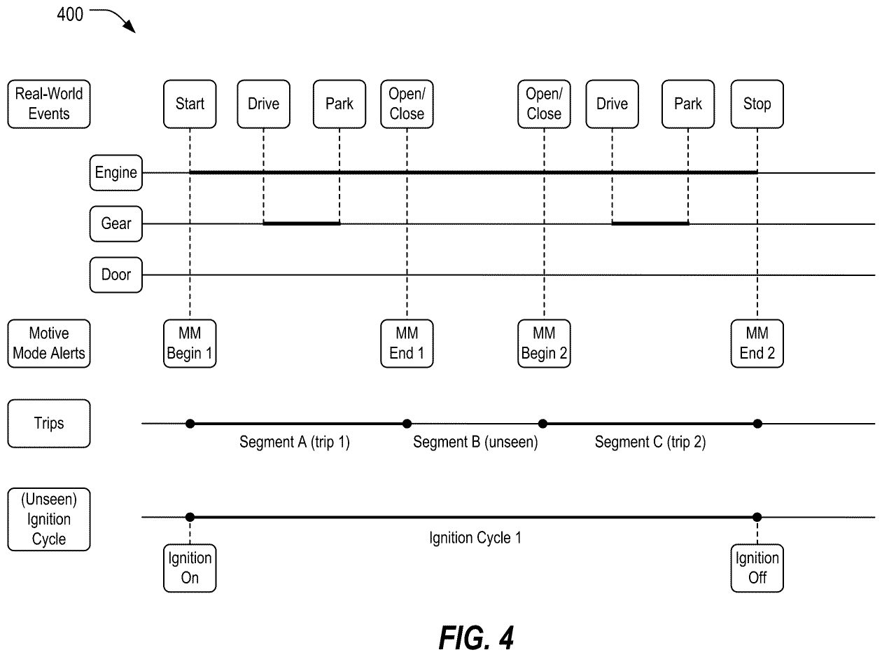

FIG. 4 illustrates an example delivery trip 400 for a vehicle 102. As shown, two trips are captured, which both correspond to a single ignition cycle. Such a pattern may occur, for example when delivering a pizza, where the vehicle 102 is exited through the door to deliver the pizza, and is then reentered, but remains on throughout that time.

There may be two levels of identifying short trips, and consequently, wait cases. The rationale behind this two-level short trip identification lies in the way the trip summary defines and identifies trips. Trip identification is based on motive mode alerts. A trip starts when a “motive mode begin alert” is received, and it ends when a “motive mode end alert” is received. The motive mode begin alert is triggered when the customer starts the vehicle 102 or opens (and in some cases enters the vehicle 102, e.g., via the driver's door). The motive mode end alert is triggered when the engine of the vehicle 102 is turned off and/or the driver's door is opened and closed.

In two-step charging situations where there are two trips prior to charging (one from an initial location to a parking area near the charging station and a second from the parking spot to the charger), if the customer opens/closes the driver side door or turns the engine on/off, the charger service 118 may define motive mode begin and motive mode end alerts and the two separate trips are identified. Based on that identification of two trips, the charger service 118 is able to check the last trip before charging to check if it was short or not.

On the other hand, there is a chance that the customer waits in the vehicle 102 without turning the engine off/on or opening/closing the door when arriving to the charging location that is congested. In this case the motive mode begin and end alerts may not trigger. Instead, only one long trip from their initial location to the EVSE 104 is identified instead of two separate trips, which may not meet the short trip criteria defined above despite the customer waiting near the charging site in the vehicle 102. For these cases, a Level 2 short trip identification is performed to prevent false negatives.

As used herein, a Level 1 short trip is defined as shown in equation (1):

Trip distance of <N meters & trip Odo change≤M (1)

where:
N is a predefined trip distance; and
M is a predefined change in trip odometer.
   N and M may be set based on the vehicle data and/or infrastructure. Thus, these values may vary from implementation to implementation. In one non-limiting example, for sake of illustration N may be 64 meters and M may be 1 odometer unit.

Responsive to identifying Level 1 short trips, adjustment cases may be identified by confirming the wait time 120 and trip distance. For example, if Trip distance <1 m and wait time <1 min, then it is most likely an adjustment case and not a true wait case where the vehicle 102 was already at the charger but had to be adjusted to be able to plug in the charger properly, and that is why the trip distance and wait time 120 were so short. These adjustment cases may be removed from Level 1 short trips and excluded from calculation of the wait time 120.

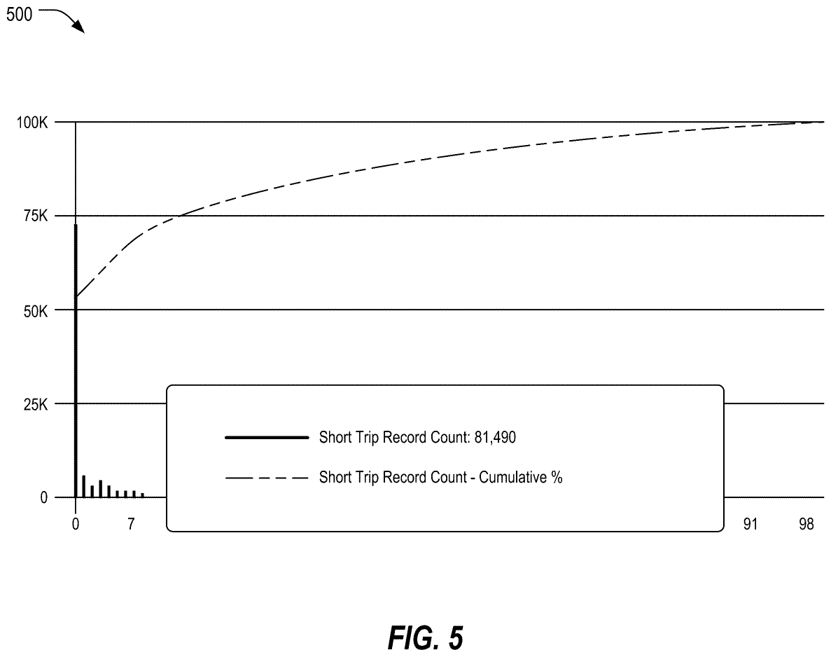

FIG. 5 illustrates a graph 500 of the distribution of trip distance for Level 1 short trips. As can be seen, there is a large component of the trips with a distance <1 m which are labeled as adjustment cases.

For cases where the Level 1 condition for a short trip is not satisfied, the approach proceeds to a Level 2 check. In situations where the trip summary does not separate the trips due to not receiving motive mode begin/end alerts, the approach may identify those trips using gear information of the vehicle 102, e.g., from the vehicle history 114.

This situation can occur when, for various reasons, the customer decides to stay in the vehicle 102 with the engine running. Examples include hot summer days when the customer keeps the vehicle 102 running to use the air conditioning, or cold days when the heat is needed. Ideally, when a customer must wait, they will put their vehicle 102 in parking mode instead of driving mode if they do not turn the vehicle 102 off. Therefore, the charger service 118 may leverage the gear pattern to identify these cases (where the motive mode begin/end alerts were not triggered), break down the long trip into smaller segments, and then determine if the last trip before charging is short or not to identify wait times 120.

To understand how the trips may be broken down into smaller ones, different gear patterns can be observed for a trip. A first pattern may be defined generally by the ordered gear positions of park, drive, park, or (P, D, P). A second pattern may be defined by the ordered gear positions of park, drive, park, drive, park (P, D, P, D, P).

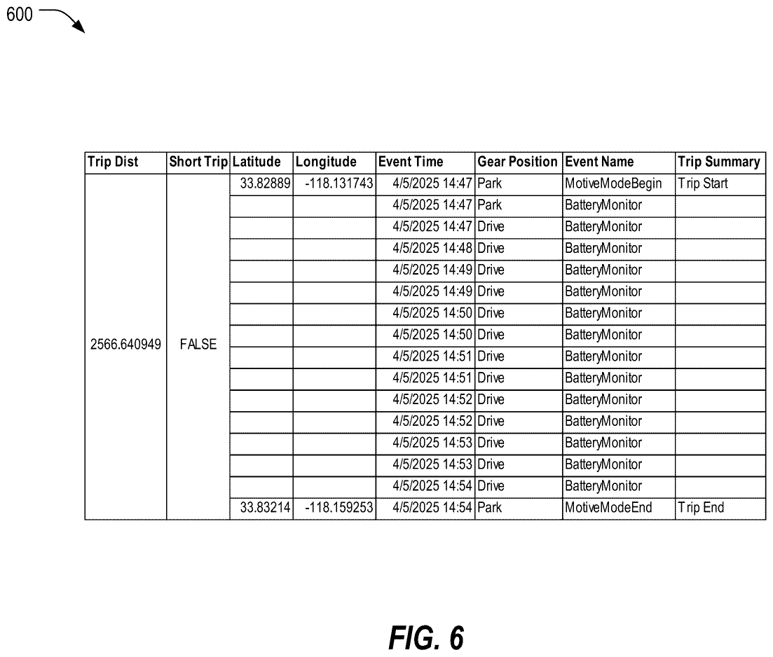

FIG. 6 illustrates an example data collection for the first pattern. Regarding the first pattern, this is the simplest pattern of gear in a trip. The customer starts the vehicle 102, changes the gear into drive and the vehicle 102 enters motive mode. After arriving at a destination, the consumer changes the gear into park and ends the trip.

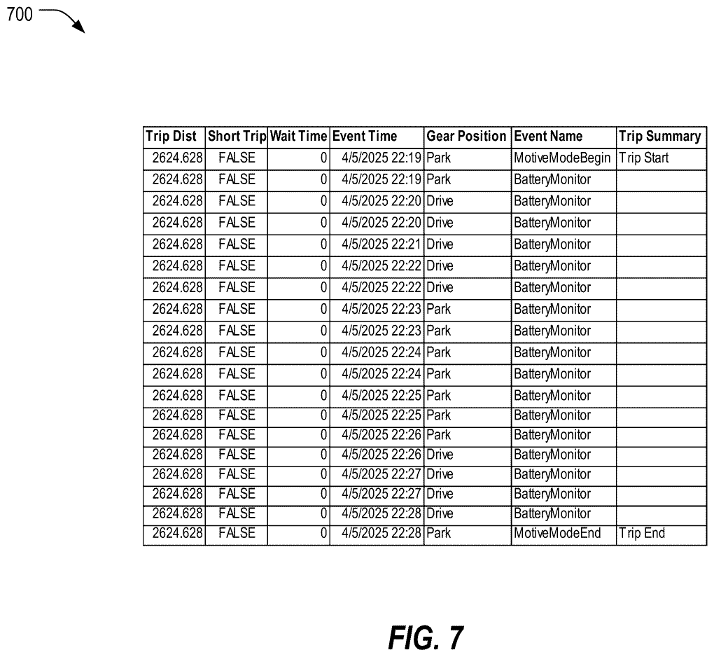

FIG. 7 illustrates an example data collection for the second pattern. Regarding the second pattern, this may occur when the consumer utilizes involve multiple drive and park sequences. In this case the consumer starts the car, changes the gear into “drive” from “park”, drives for a while, then stops and puts the gear into “park”, and after a while they start driving again. This switch between “park” and “drive” may happen multiple times, so the pattern may extend to potentially many repeated transitions such as: (P, D, P, D, . . . , D, P).

A similar gear pattern may be observed in cases where driver starts driving (D) from an initial location, traveling to a congested charging station, and waits in the running vehicle 102 while putting the gear in the park (P), and then drives again (D) towards the EVSE 104 as soon as one becomes available. In this example the gear pattern would look like: (P, D, P, D, P). Such a pattern may be decomposed into two smaller trips such as like (P, D, P), (P, D, P) where the latter trip is checked against the short trip condition.

The operations for the Level 2 identification thus include to (i) extract the gear pattern for the trip before charging; (ii) check if there are more than one driving session in the gear pattern; (iii) separate the trip into smaller trip so that every trip has only one driving session; and (iv) check the very last trip to see whether it is a short trip and calculate the wait time 120 accordingly.

Ideally, the Level 2 short trip criteria should match the Level 1 criteria. However, due to differences in data availability, such as the time resolution of GNSS values during trips, the criteria for Level 2 identification may be different. The GNSS values may only be received for the start and end of the trips provided in the trip summary, not for points in between. Consequently, after breaking the trip down into smaller segments, intermediate GNSS values may be unavailable to calculate the straight-line distance between the start and end points of these smaller trips to use as a short trip criterion. Therefore, trip duration may instead be used. If the driver is traveling from a parking spot very close to the charging station to an EVSE 104, the driving duration should not be very long. Thus, it is reasonable to use trip duration instead of distance in this specific case.

The final trip before charging after breaking down using gear pattern is considered a short trip if it satisfies the conditions of equation (2):

Trip duration<T min and Trip Odo change<=M (2)

where:
T is a predefined trip distance; and
M is a predefined change in trip odometer.
   T and M may be set based on the vehicle data and/or infrastructure. Thus, these values may vary from implementation to implementation. In one non-limiting example, for sake of illustration T may be 5 minutes and M may be 1 odometer unit (e.g., or another value consistent with M for Level 1 trip determination). It should be noted that these values may differ from Level 1, for example, due to differences in data availability.

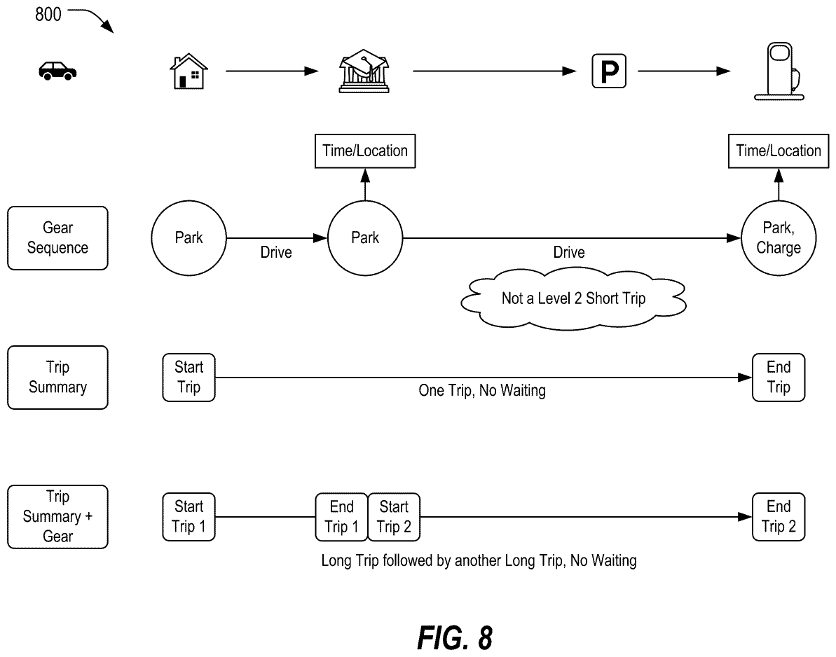

FIG. 8 illustrates an example 800 of breaking down a trip into two, where the second trip is not a short trip. As can be seen, the end broken out trip is does not meet the criteria for being a Level 2 short trip.

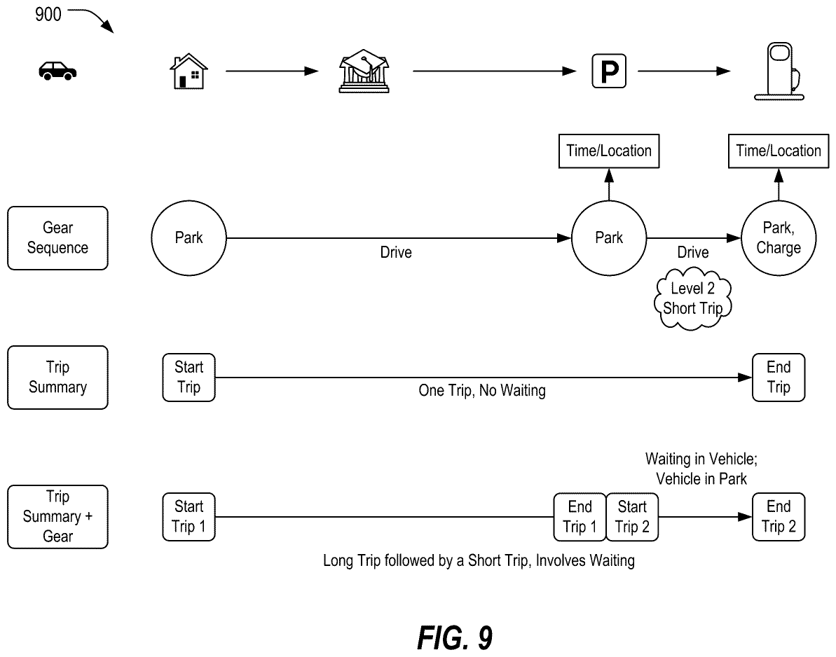

FIG. 9 illustrates an example 900 of breaking down a trip into two, where the second trip is a short trip. As can be seen, the end broken out trip here does meet the criteria for being a Level 2 short trip.

Turning to performing a wait time 120 calculation, after identifying short trips (either using Level 1 or Level 2 identification techniques) wait time 120 can be calculated according to equation (3):

Wait time=trip end time−previous trip end time (3)

In this formula the trip end time will be the same for Level 1 and Level 2 cases. It is the end of the last trip before charging that was matched from trip summary to the plug attempt. However, the previous trip end time may be slightly different for the two levels of identification.

For Level 1 short trips, previous trip end time refer to the end time of the second to the last trip (from trip summary) before the plug attempt. However, for Level 2 short trip, the second to the last trip is defined before charging after breaking the trip from trip summary into smaller ones using the gear information.

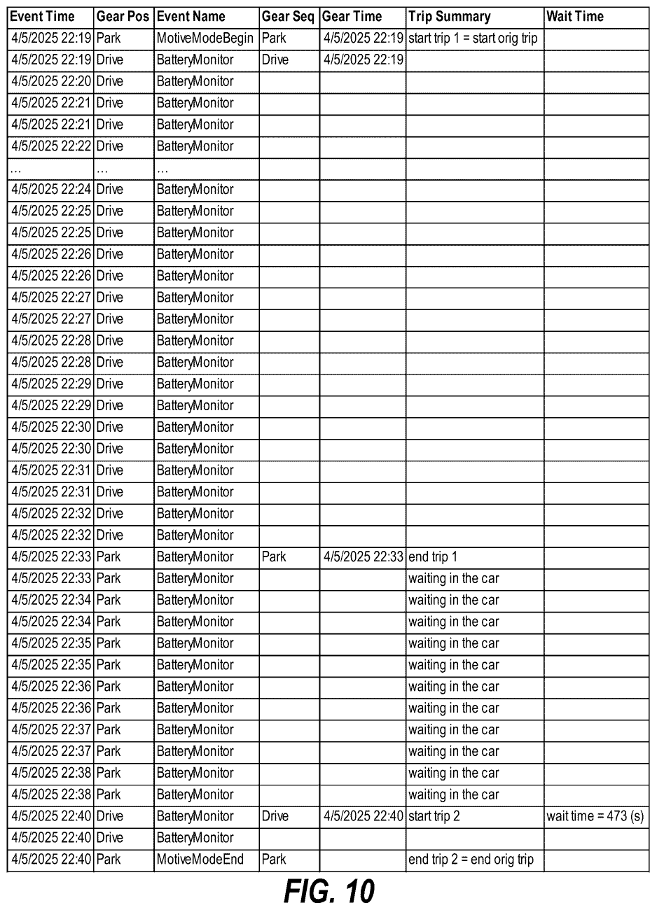

When breaking down a trip, each smaller trip may only have one driving sequence in it. For example, FIG. 10 shows a trip with pattern (P, D, P, D, P), which means following the logic for defining a trip, this can be divided into two smaller trips as (P, D, P), (P, D, P). The final (P, D, P) sequence will the last trip before charging which here we will call trip 2, and the first (P, D, P) is the second-to-last trip which here may be referred to as trip 1. So, the end of trip 1 will be previous trip end time. The first “park” signal after the last “drive” signal in trip 1 may be used as the end of trip 1. The start of trip 2 is the first occurrence of “drive” in the last trip (trip 2 here), and end of trip 2 is the same as end of the trip form trip summary. Finally, the “end of trip 1”, i.e., previous trip end time, and “end of trip 2” i.e., trip end time, may be used in wait time calculation as shown in the equation (3) above.

This methodology can be further generalized to account for cases where a customer takes multiple short trips before initiating charging. For instance, if a driver arrives at a congested charging station and makes several minor relocations (e.g., from one parking spot to another or within the area surrounding the station) before finally starting to charge, these trips can collectively be treated as part of the wait time 120. In such scenarios, the total wait time 120 can be calculated as the difference between the end of last trip before charging and the end of the last significant (long) trip prior to these short trips. By aggregating these short trips into a single waiting period, we can more accurately reflect the customer's experience at congested charging stations, ensuring the algorithm remains robust across diverse charging scenarios.

Turning to the wait-time adjustment using regional EV density data, many approaches model public charging wait time 120 as a queuing model. In mathematical queueing theory, Little's law is a theorem by John Little which states that the long-term average number L of customers in a stationary system is equal to the long-term average effective arrival rate/multiplied by the average time W that a customer spends in the system. Expressed algebraically the law is:

L=λW (4)

To make this long-term stationary system more realistic in the real world, the queuing model can be categorized as M/M/m, M/G/m, or M/D/m model. In this context, the first “M” stands for Markov chain, indicating that it can be modeled as a Poisson process in terms of arrival rate. The second letter, “M”, “G”, or “D” represents Markov chain service distribution, general service distribution, or deterministic service distribution, respectively. The last “m” signifies the number of servers, which in this case refers to the EVSE 104.

Using M/M/m as an example, this assumes exponential interarrival and service times, and multiple servers. We can formulate an estimation of waiting time as follows:

$${Ω}_{q} = \frac{\frac{{( λ / μ )}^{n}}{n ! {( n μ - λ )}^{2}}}{{\sum }_{i = 0}^{n - 1} \frac{{( λ / μ )}^{i}}{i !} + {\sum }_{i = n}^{∞} \frac{{( λ / μ )}^{i}}{{n}^{i - n} n !}} \qquad ( 5 )$$

where:
n is the number of EVSEs 104;
λ is the arrival rate in vehicles 102 per minute, and
μ is the service rate in vehicles 102 per minute.

Therefore, if the mean arrival rate λ and the mean service rate μ are available, wait time 120 may be estimated. A reverse engineering method may be used since a data-driven wait time 120 estimation is more accurate than theoretical equations. Assuming the customer has started their trip, the expected arrival rate λ₀ may be determined based on available information. For service time, the EVSE 104 streaming data may be used as a source to extract charging events, with the duration of these events used to calculate service time.

Next, a geospatial fence is established with a threshold around the charging station. Based on the number of EVs with a SOC below 20%, a probability can be assigned of charging for each EV. For instance, if the SOC is below 10%, the customer may be assumed to be heading to the location, thus the probability is 100%. If the SOC is below 30%, a probability of 50% may be assigned. This allows for the charger service 118 to calculate an expected number of X EVs in the next Y minutes, where Y is the travel time of the customer.

The expected number of vehicles 102 arriving at the selected charging station can be formulated as follows:

$$E [ N ] = {N}_{d} + {\sum }_{i = 1}^{m} {e}^{- β {SOC}_{m} + {C}_{p}} \qquad ( 6 )$$

where:
E[N] represents the expected number of EVs that have arrived at the selected charging station by the time the current driver arrives;
N_{d} is the confirmed number of EVs from the trip planner app or as known by the charging station that are currently waiting;
m denotes the number of EVs within the selected geospatial region;
SOCₘ is the state of charge of the m^{th} EV battery; and
Cₚ is the popularity score of the current charging station, as the geospatial region may contain multiple charging stations.

The E[N] can be converted into the arrival rate and used to fine-tune the offline estimated wait time 120. A wait-time score may be formulated for situations where the adjusted wait time 120 is significantly higher than historical data, thereby providing EV drivers with a heads-up to replan their trip.

Thus, EV public charging wait times 120 may be estimated by passively analyzing vehicle 102 data, rather than relying on driver surveys. Moreover, this approach fine-tunes vehicle 102 arrival rates by using EV density. This can be converted into a score to alert drivers when extremely high wait times 120 may be expected, as compared to statistical methods. In addition, a three-phase wait-time estimation and prediction approach is provided by leveraging both physics-based and data-driven service time calculations.

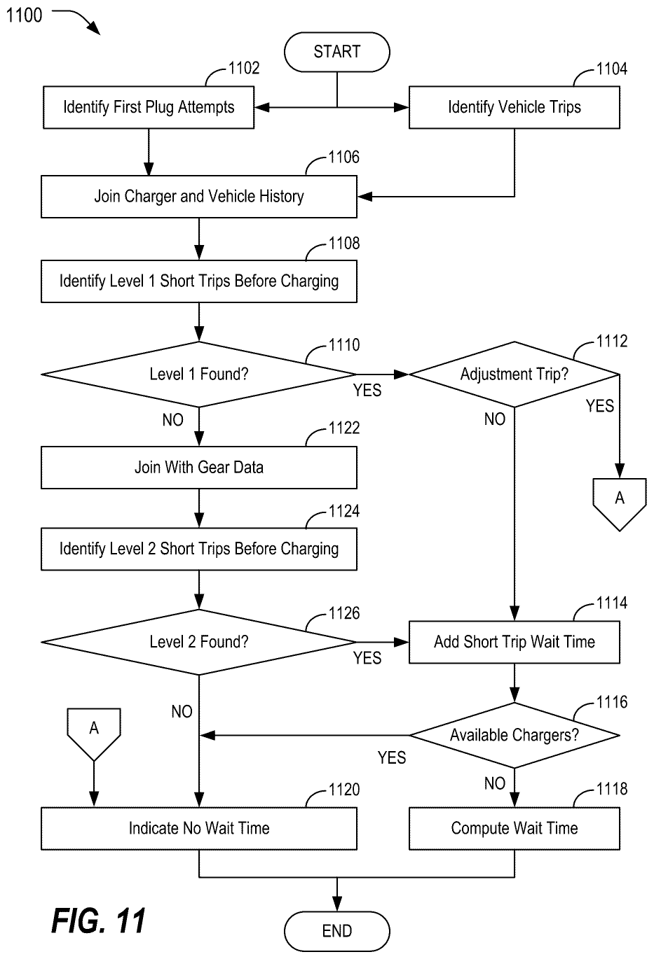

FIG. 11 illustrates an example process 1100 for public charging wait-time estimation and prediction. In various examples, the process 1100 may be executed by the system 100, and in particular by the charger monitoring server 112 executing the charger service 118. The charger monitoring server 112 may have received the vehicle histories 114 from the vehicles 102 and the charger histories 116 from the EVSEs 104 to perform the process 1100. The process 1100 enables the system 100 to determine, for a given charging event, whether a wait occurred prior to plug-in, and if so, to compute the corresponding wait time 120 with precision based on structured vehicle 102 and charger telemetry.

At operation 1102, the charger service 118 identifies first plug-in attempts from the charger histories 116. This identification may include querying charging event data to extract the initial plug-in timestamp associated with each charging session for each vehicle 102. The plug-in attempt is associated with metadata including a timestamp, vehicle identifier (e.g., VIN), EVSE 104 identifier, plug-in SOC, and charging session details such as rate and duration. The extracted records form a “plug table” for subsequent analysis.

At operation 1104, the charger service 118 retrieves and structures trip data from the vehicle histories 114. In an example, the trips may be sorted in ascending order by start timestamp and partitioned by VIN. Lag and lead window functions may be applied to obtain the end time of the previous trip and the start time of the next trip for each vehicle 102, respectively. The resulting dataset, referred to as the “trip table,” includes timestamps, GNSS coordinates, odometer readings, and other trip-level telemetry.

At operation 1106, the charger service 118 joins the plug table and trip table to associate each plug-in attempt with its preceding trip. This join may be performed by matching the VIN and ensuring that the plug-in time is greater than or equal to the end time of the previous trip and less than or equal to the start time of the next trip. The resulting joined table associates each plug-in attempt with the relevant trip context for subsequent short trip and wait-time analysis.

At operation 1108, the charger service 118 determines whether the last trip preceding the plug-in event constitutes a short trip under Level 1 criteria. Specifically, the trip is considered a Level 1 short trip if (i) the GNSS-calculated distance between trip origin and destination is less than 64 meters, and (ii) the change in odometer reading during the trip is less than or equal to one unit. Distance between GNSS coordinates is computed using geospatial functions (e.g., via BigQuery) based on the latitude and longitude of the trip origin and destination.

If these Level 1 criteria are met, at operation 1112 the charger service 118 proceeds to evaluate whether the identified trip represents an adjustment case, i.e., a scenario in which the vehicle 102 was already positioned at the EVSE 104 but was slightly moved to facilitate plug-in. A trip is classified as an adjustment case if (i) the GNSS distance is less than 1 meter, and (ii) the time between the current trip end and the previous trip end is less than 1 minute. Adjustment cases are excluded from wait-time estimation.

At operations 1110 and 1112, the charger service 118 evaluates the outcome of the Level 1 short trip identification. If a valid Level 1 short trip (not an adjustment case) is detected, control proceeds to operation 1114.

At operation 1114, the charger service 118 computes the estimated wait time 120 as the difference between the end time of the final trip before charging and the end time of the prior trip. For Level 1 cases, both timestamps are obtained from the trip summary table and represent clearly defined trip boundaries.

At operation 1116, the charger service 118 verifies whether a charger was available at the time of the plug-in event. This may be determined by inspecting the EVSE 104 streaming status within the charger histories 116 to identify the occupancy state of chargers at the station at the plug-in timestamp. If all chargers were occupied, the customer is inferred to have waited prior to charging.

At operation 1118, responsive to a determination that no EVSE 104 was available, the wait time 120 computed at operation 1114 is finalized and stored as the wait time 120. This value may be used to update predictive queuing models, inform recommendation systems, or be presented to the user via HMI or mobile application interfaces.

If, at operation 1116, if the charger service 118 determines that a charger was available at the time of plug-in (i.e., the customer did not have to wait), control proceeds to operation 1120.

Also, if at operation 1112 a Level 1 trip is found to be an adjustment trip, control also proceeds to operation 1120. At operation 1120, the charger service 118 indicates that the wait time 120 is zero. This indication may be stored in the same data structure used for wait-time statistics and may be communicated to downstream services, such as recommendation engines that factor in charging efficiency. The process 1100 then ends.

If at operation 1116, it is determined that at least one EVSE 104 was available at plug-in time, the charger service 118 proceeds to operation 1120, where the wait time 120 is recorded as zero.

If, at operation 1110, no Level 1 short trip is detected, control proceeds to operation 1122, wherein the charger service 118 performs Level 2 short trip identification based on gear state data. In this path, the joined table is further joined with gear-level telemetry (e.g., tcu4g data), including sequences of gear states (e.g., Park, Drive, Park) recorded during trips.

At operation 1122, the charger service 118 analyzes the gear pattern of the final long trip before charging to detect drive-park-drive (PDP) patterns. The presence of such a pattern suggests that the customer may have waited near the charging location with the engine running and then moved the vehicle 102 when a charger became available. The trip is segmented into one or more sub-trips, each defined by a single (P, D, P) sequence.

At operation 1124, the final sub-trip preceding the plug-in event is evaluated by the charger service 118 under Level 2 short trip criteria. A sub-trip is considered a Level 2 short trip if (i) its duration is less than 5 minutes (300 seconds), and (ii) the odometer change is less than or equal to one unit. These relaxed criteria are used in lieu of GNSS distance due to the absence of intermediate GNSS resolution in segmented sub-trips.

At operation 1126, if a valid Level 2 short trip is detected, control proceeds to operation 1114, and the wait time 120 is computed using timestamps derived from the segmented trip structure. Specifically, the wait time 120 is calculated as the difference between the end time of the final (P, D, P) sub-trip and the end time of the prior (P, D, P) sub-trip. If no valid Level 2 short trip is found at operation 1126, the system proceeds to operation 1120, where the wait time 120 is recorded as zero, and the process 1100 terminates.

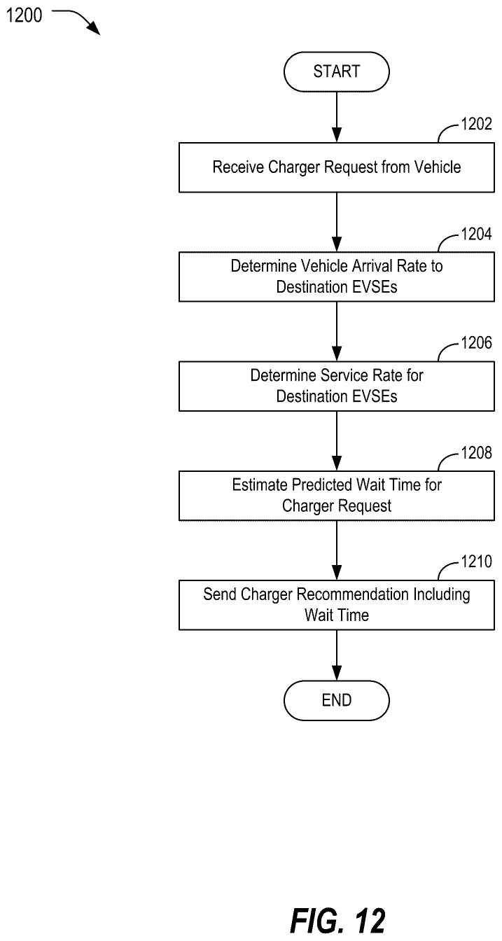

FIG. 12 illustrates an example process 1200 for responding to charger requests 124. In various examples, the process 1200 may be executed by the system 100, and in particular by the charger monitoring server 112 executing the charger service 118. The process 1200 enables the system 100 to utilize the wait times 120 determined using the process 1100 for individual vehicles 102 based on Level 1 and Level 2 short trip identification as ground truth data for training a predictive model. The predictive model may be used to generate real-time wait-time predictions in response to incoming charger requests 124.

At operation 1202, the charger service 118 receives a charger request 124 from a vehicle 102. The request may originate from onboard the vehicle 102, such as an energy management or navigation controller, or from a user mobile device 106 connected to the vehicle 102. The charger request 124 includes at least a destination corresponding to one or more EVSEs 104 and a SOC value of the battery of the vehicle 102. In some examples, the charger request 124 may further include the estimated time of arrival at the station, route data, or other contextual metadata derived from trip planning services.

At operation 1204, the charger service 118 determines an arrival rate of vehicles 102 to the EVSEs 104 of the charging station identified in the charger request 124. To compute this arrival rate, the charger service 118 may first establish a geospatial fence around the destination charging station, such as a circular region of interest centered on the station with a predefined radius. The charger service 118 then queries recent and current vehicle 102 telemetry, such as GNSS position and SOC values, from vehicles 102 operating within the geofenced region. The charger service 118 assigns a charging probability to each nearby vehicle 102 based on its SOC, with lower SOC values corresponding to higher likelihoods of forthcoming charging activity. For instance, vehicles 102 with SOC values below 10% may be assigned a 100% charging probability, while vehicles 102 with SOC values below 30% may be assigned a 50% probability. In some examples, the arrival rate may also be weighted by a popularity score associated with the destination station, such as a score reflecting its historical usage frequency relative to nearby stations. The charger service 118 may further incorporate destination confirmations from third-party trip planners (e.g., navigation applications) when such data is available, thereby improving the accuracy of the predicted arrival rate 2.

At operation 1206, the charger service 118 determines a service rate for the destination station. The service rate may be computed based on historical charging session data obtained from charger histories 116. The charger service 118 identifies past charging events at the relevant EVSEs 104, extracts the start and end times of those sessions, and calculates corresponding charge durations. These durations may be normalized based on vehicle 102 characteristics (e.g., battery size or make/model), charger type (e.g., Level 2 or DC fast), and environmental conditions (e.g., temperature), where available. The charger service 118 may aggregate these durations to derive an average or expected service time, and then invert this time to calculate a mean service rate μ in vehicles 102 per unit time. In some examples, variance metrics may also be stored to support more advanced queuing models such as M/G/m. If streaming performance data is available for the EVSEs 104, such as real-time charging throughput or reported errors, the service rate may be adjusted to reflect current operational conditions.

At operation 1208, the charger service 118 applies a trained prediction model to estimate the predicted wait time 120 for the requesting vehicle 102. The prediction model may include a queuing-theoretic component, such as an M/M/m model, M/D/m model, or M/G/m model, in which the number of servers (m) corresponds to the number of EVSEs 104 at the station. The arrival rate 2 and service rate μ determined in operations 1204 and 1206 are applied as parameters to this model. Alternatively, or additionally, the charger service 118 may invoke a machine learning model that has been trained on historical vehicle 102 and charger behavior using wait time 120 labels generated via the Level 1 and Level 2 trip segmentation processes described above. The selected model generates a personalized wait-time prediction for the requesting vehicle 102 based on the predicted queue length, expected turnover, and other contextual information. The model may also incorporate real-time charger availability status or apply scores for congestion scenarios.

At operation 1210, the charger service 118 transmits the predicted wait time 120 to the vehicle 102. The predicted wait time 120 may be included in a charger recommendation 126 and transmitted via the TCU 110 of the vehicle 102 or a connected mobile device 106. The wait time 120 may be displayed via the user interface of the vehicle 102 (e.g., dashboard or center display) or within a mobile application executed by the mobile device 106. In some cases, the charger recommendation 126 may include additional context such as queue length, nearby alternative stations, or available amenities. After transmitting the recommendation, the process 1200 ends.

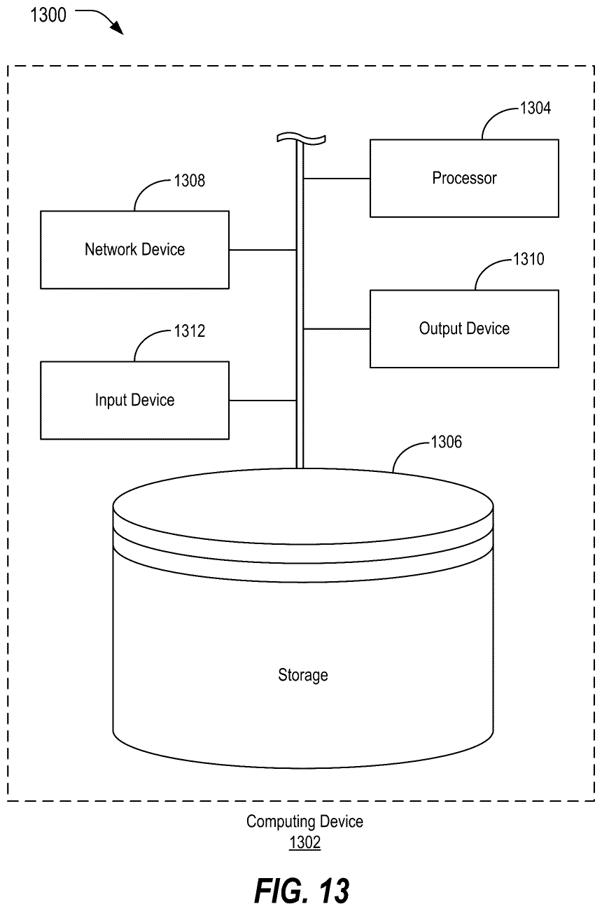

FIG. 13 illustrates an example computing device 1302 for implementing aspects of public charging wait-time estimation and prediction. Referring to FIG. 13, and with reference to FIGS. 1-12, the vehicle 102, EVSEs 104, mobile devices 106, communications network 108, TCU 110, charger monitoring server 112 may include examples of such computing devices 1302. Computing devices 1302 generally include computer-executable instructions, where the instructions may be executable by one or more computing devices 1302. Computer-executable instructions may be compiled or interpreted from computer programs created using a variety of programming languages and/or technologies, including, without limitation, and either alone or in combination, Java™, C, C++, C#, Visual Basic, Python, Perl, etc. In general, a processor (e.g., a microprocessor) receives instructions, e.g., from a memory, a computer-readable medium, etc., and executes these instructions, thereby performing one or more processes, including one or more of the processes described herein. Such instructions, such as those of the charger service 118 and charger application 122, and other data, such as the vehicle histories 114, charger histories 116, charger wait times 120, charger requests 124, and charger recommendations 116, may be stored and transmitted using a variety of computer-readable media.

As shown, the computing device 1302 may include a processor 1304 that is operatively connected to a storage 1306, a network device 1308, an output device 1310, and an input device 1312. It should be noted that this is merely an example, and computing devices 1302 with more, fewer, or different components may be used.

The processor 1304 may include one or more integrated circuits that implement the functionality of a central processing unit (CPU) and/or graphics processing unit (GPU). In some examples, the processors 1304 are a system on a chip (SoC) that integrates the functionality of the CPU and GPU. The SoC may optionally include other components such as, for example, the storage 1306 and the network device 1308 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 1304 executes stored program instructions that are retrieved from the storage 1306. The stored program instructions, accordingly, include software that controls the operation of the processors 1304 to perform the operations described herein. The storage 1306 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 1310. The output device 1310 may include a graphical or visual display device, such as an electronic display screen, projector, printer, or any other suitable device that reproduces a graphical display. As another example, the output device 1310 may include an audio device, such as a loudspeaker or headphone. As yet a further example, the output device 1310 may include a tactile device, such as a mechanically raiseable device that may, in an example, be configured to display braille or another physical output that may be touched to provide information to a user.

The input device 1312 may include any of various devices that enable the computing device 1302 to receive control input from users. Examples of suitable input devices 1312 that receive human interface inputs may include keyboards, mice, trackballs, touchscreens, microphones, graphics tablets, and the like.

The network devices 1308 may each include any of various devices that enable the described components to send and/or receive data from external devices over networks. Examples of suitable network devices 1308 include an Ethernet interface, a Wi-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for predicting a wait time for an electric vehicle (EV) at a charging station, comprising:
receiving, at a server, a charger request from an EV including at least a destination and a state of charge (SOC) value;
determining an arrival rate of EVs to the charging station based on at least one of: vehicle density in a geofenced region around the charging station or SOC values of nearby EVs;
determining a service rate of the charging station based on historical charging event data;
applying a trained prediction model to the request based on the arrival rate and the service rate to estimate a predicted wait time for the EV at the charging station; and
transmitting the predicted wait time to a user interface associated with the EV.

2. The method of claim 1, wherein the trained prediction model is based on historical wait times determined using:
Level 1 short trip identification using trip distance and odometer change thresholds; and
Level 2 short trip identification using segmentation of trip gear patterns into sub-trips and evaluation of a final sub-trip based on duration and odometer change.

3. The method of claim 1, further comprising generating training data for the prediction model by:
receiving, at the server, charging event data including plug-in timestamps associated with charging sessions for a plurality of EVs;
retrieving, from a vehicle history database, a plurality of trips associated with the plurality of EVs;
for each EV:
identifying, from the plurality of trips, a final trip ending before the plug-in timestamp;
determining whether the final trip is a Level 1 short trip after a preceding trip based on one or more of: a trip distance of the final trip being less than a threshold value and an odometer change of the final trip being less than or equal to a predefined threshold;
responsive to the final trip not satisfying Level 1 short trip criteria, further determining analyzing a gear pattern of the final trip to determine whether the gear pattern includes a last sub-trip meeting criteria for being a Level 2 short trip, the last sub-trip being usable as the final trip and a prior sub-trip or trip being usable as the preceding trip; and
responsive to the final trip being a Level 1 short trip or a Level 2 short trip, determining a historical wait time as a difference between an end time of the final trip and an end time of the preceding trip;
wherein the historical wait times are aggregated and used to train the prediction model.

4. The method of claim 3, further comprising excluding the final trip from being the Level 1 short trip as an adjustment case responsive to the trip distance being below an adjustment distance threshold and the difference between the end time of the final trip and the end time of the preceding trip being less than an adjustment time threshold.

5. The method of claim 3, wherein determining the Level 2 short trip includes:
segmenting the final trip into a plurality of sub-trips based on the gear pattern;
identifying a last sub-trip prior to the plug-in timestamp; and
determining whether the last sub-trip is a Level 2 short trip based on a duration of the sub-trip being less than a Level 2 duration threshold and an odometer change of the sub-trip being less than or equal to a Level 2 predefined threshold.

6. The method of claim 5, wherein the segmenting is performed when the gear pattern matches a pattern of alternating Park and Drive gear positions.

7. The method of claim 3, further comprising verifying whether a charger was available at a time of the plug-in timestamp by analyzing a charger occupancy status.

8. The method of claim 7, wherein responsive to determining that at least one charger was available at the plug-in timestamp, the wait time is recorded as zero.

9. The method of claim 1, wherein the trained prediction model comprises a queuing model, wherein the queuing model is one of an M/M/m model, an M/D/m model, or an M/G/m model.

10. The method of claim 1, wherein determining the arrival rate includes:
assigning a charging probability to each EV within the geofenced region based on a SOC threshold; and
weighting the arrival rate using a popularity score of the charging station.

11. A server for predicting a wait time for an electric vehicle (EV) at a charging station, comprising:
a memory storing instructions of a charger service; and
one or more computing devices configured to execute the instructions to perform operations including to:
receive a charger request from an EV including at least a destination and a state of charge (SOC) value,
determine an arrival rate of EVs to the charging station based on at least one of: vehicle density in a geofenced region around the charging station or SOC values of nearby EVs,
determine a service rate of the charging station based on historical charging event data,
apply a trained prediction model to the request based on the arrival rate and the service rate to estimate a predicted wait time for the EV at the charging station, and
transmit the predicted wait time to a user interface associated with the EV.

12. The server of claim 11, wherein the trained prediction model is based on historical wait times determined using:
Level 1 short trip identification using trip distance and odometer change thresholds; and
Level 2 short trip identification using segmentation of trip gear patterns into sub-trips and evaluation of a final sub-trip based on duration and odometer change.

13. The server of claim 11, wherein the one or more computing devices are further configured to execute the instructions to perform operations to generate training data for the prediction model including to:
receive at the server, charging event data including plug-in timestamps associated with charging sessions for a plurality of EVs;
receive, from a vehicle history database, a plurality of trips associated with the plurality of EVs;
for each EV:
identify, from the plurality of trips, a final trip ending before the plug-in timestamp;
determine whether the final trip is a Level 1 short trip after a preceding trip based on one or more of: a trip distance of the final trip being less than a threshold value and an odometer change of the final trip being less than or equal to a predefined threshold;
responsive to the final trip not satisfying Level 1 short trip criteria, further determine analyzing a gear pattern of the final trip to determine whether the gear pattern includes a last sub-trip meeting criteria for being a Level 2 short trip, the last sub-trip being usable as the final trip and a prior sub-trip or trip being usable as the preceding trip; and
responsive to the final trip being a Level 1 short trip or a Level 2 short trip, determine a historical wait time as a difference between an end time of the final trip and an end time of the preceding trip;
wherein the historical wait times are aggregated and used to train the prediction model.

14. The server of claim 13, wherein the one or more computing devices are further configured to execute the instructions to perform operations including to exclude the final trip from being the Level 1 short trip as an adjustment case responsive to the trip distance being below an adjustment distance threshold and the difference between the end time of the final trip and the end time of the preceding trip being less than an adjustment time threshold.

15. The server of claim 13, wherein to determine the Level 2 short trip includes to:
segment the final trip into a plurality of sub-trips based on the gear pattern;
identify a last sub-trip prior to the plug-in timestamp; and
determine whether the last sub-trip is a Level 2 short trip based on a duration of the sub-trip being less than a Level 2 duration threshold and an odometer change of the sub-trip being less than or equal to a Level 2 predefined threshold.

16. The server of claim 15, wherein the segmentation is performed when the gear pattern matches a pattern of alternating Park and Drive gear positions.

17. The server of claim 13, wherein the one or more computing devices are further configured to execute the instructions to perform operations including to:
verify whether a charger was available at a time of the plug-in timestamp by analyzing a charger occupancy status; and
responsive to determining that at least one charger was available at the plug-in timestamp, the wait time is recorded as zero.

18. The server of claim 11, wherein the trained prediction model comprises a queuing model, wherein the queuing model is one of an M/M/m model, an M/D/m model, or an M/G/m model.

19. The server of claim 11, wherein determining the arrival rate includes to:
assign a charging probability to each EV within the geofenced region based on a SOC threshold; and
weight the arrival rate using a popularity score of the charging station.

20. A non-transitory computer-readable medium comprising instructions of a charger service for predicting a wait time for an electric vehicle (EV) at a charging station that, when executed by one or more computing devices of a charger server, cause the charger server to perform operations including to:
receive at the server, charging event data including plug-in timestamps associated with charging sessions for a plurality of EVs;
receive, from a vehicle history database, a plurality of trips associated with the plurality of EVs;
for each EV, determine historical wait times including to:
identify, from the plurality of trips, a final trip ending before the plug-in timestamp;
determine whether the final trip is a Level 1 short trip after a preceding trip based on one or more of: a trip distance of the final trip being less than a threshold value and an odometer change of the final trip being less than or equal to a predefined threshold;
responsive to the final trip not satisfying Level 1 short trip criteria, further determine analyzing a gear pattern of the final trip to determine whether the gear pattern includes a last sub-trip meeting criteria for being a Level 2 short trip, the last sub-trip being usable as the final trip and a prior sub-trip or trip being usable as the preceding trip; and
responsive to the final trip being a Level 1 short trip or a Level 2 short trip, determine a historical wait time as a difference between an end time of the final trip and an end time of the preceding trip;
receive a charger request from an EV including at least a destination and a state of charge (SOC) value;
determine an arrival rate of EVs to the charging station based on at least one of: vehicle density in a geofenced region around the charging station or SOC values of nearby EVs;
determine a service rate of the charging station based on historical charging event data;
apply to the request, a model trained using the historical wait times, based on the arrival rate and the service rate to estimate a predicted wait time for the EV at the charging station; and
transmit the predicted wait time to a user interface associated with the EV.
